(19) United States
(12) Patent Application Publication
(10) Pub. No.: US 2013/0154979 A1
(43) Pub. Date: Jun. 20, 2013

(54) TOUCH PANEL HAVING ELECTROSTATIC PROTECTION STRUCTURE

(71) Applicant: WINTEK CORPORATION, Taichung City (TW)

(72) Inventors: Chung-Hsien Li, Taichung City (TW); Yu-Ting Chen, Pingzhen City (TW); Jiann-Liang Chou, New Taipei City (TW)

(73) Assignee: WINTEK CORPORATION, Taichung City (TW)

(21) Appl. No.: 13/717,743

(22) Filed: Dec. 18, 2012

(30) Foreign Application Priority Data
Dec. 19, 2011 (TW) 100147223
Dec. 3, 2012 (TW) 101145309

(51) Int. Cl. G06F 3/041

(52) U.S. Cl. CPC G06F 3/041
USPC 345/173

(57) ABSTRACT

A touch panel having an electrostatic protection structure includes a transparent substrate, multiple sensing electrodes, a decoration layer and the electrostatic protection structure. The transparent substrate has an active region and a decoration region surrounding the active region. The sensing electrodes are formed on the active region. The decoration layer is disposed on the decoration region. The electrostatic structure includes a conductive ring. The conductive ring is disposed in surrounding arrangement corresponding to the decoration region and is located between the decoration layer and the transparent substrate.

This application claims the benefits of Taiwan application Serial No. 100147223, filed Dec. 19, 2011 and Serial No. 101145309, filed Dec. 3, 2012, the subject matters of which are incorporated herein by reference.

### BACKGROUND OF THE INVENTION

1. Field of the Invention

The invention relates in general to a touch panel, and more particularly to a touch panel having an electrostatic protection structure.

2. Description of the Related Art

The market share of touch panels continues to rise in consumer electronic products ever since touch panels are first developed. Touch display panels integrating touch control and display functions are currently market-available, and are applied to portable consumer electronic products such as wireless communication cell phones, laptop computers, tablet computers and digital cameras.

In a common electronic product integrated with a touch function, a touch panel and a display panel are directly assembled to each other, and control signals and display signals are transmitted via respective signal lines. Another conventional solution, including a touch unit being directly integrated to a transparent substrate, is advantaged by being low in cost, high in light transmittance and small in thickness. On the other hand, such solution fails in providing good electrostatic protection as it lacks satisfactory structural protection. In a current electrostatic protection mechanism, an additional conductive wire is disposed to discharge an instantaneous large current. However, the current electrostatic protection mechanism cannot cover the entire touch panel, leading to issues of degraded electrostatic protection capabilities and lowered light transmittance due to an additionally manufactured film.

### SUMMARY OF THE INVENTION

The invention is directed to a touch panel having an electrostatic protection structure for enhancing electrostatic protection capabilities without affecting light transmittance of the touch panel.

According to an aspect of the present invention, a touch panel having an electrostatic protection structure is provided. The touch panel includes a transparent substrate, multiple sensing electrodes, a decoration layer and the electrostatic protection structure. The transparent substrate has an active region and a decoration region surrounding the active region. The sensing electrodes are formed on the active region. The decoration layer is disposed on the decoration region. The electrostatic protection structure includes a conductive ring. The conductive ring is disposed in a surrounding arrangement corresponding to the decoration region, and is located between the decoration layer and the transparent substrate.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1A is a schematic diagram of a touch panel having an electrostatic protection structure according to an embodiment of the present invention.

FIGS. 1B and 1C are sectional views along a section line I-I′ in FIG. 1A according to two embodiments of the present invention.

FIGS. 2A and 2B depict a conductive ring according to two other embodiments.

FIGS. 3A to 3C depict a conductive ring according to three other embodiments.

FIG. 3D depicts a conductive ring according to another embodiment.

FIG. 4 depicts a dielectric layer and a decoration layer located between a conductive wire and a conductive ring.

FIGS. 5A to 5D are variations of an electrostatic protection structure.

FIG. 6A is a top view of a touch sensing element disposed in a sensing region in FIG. 1A.

FIG. 6B is a sectional view of the touch sensing element in FIG. 6A along a section line A-A′.

FIGS. 7 to 9 are schematic diagrams of three variations of the touch sensing element in FIGS. 6A and 6B.

FIG. 10A is a top view of a touch sensing element disposed in a sensing region in FIG. 1A.

FIG. 10B is a sectional view of the touch sensing element in FIG. 10A along a section line A-A′.

FIG. 11 is a schematic diagram of a variation of the touch sensing element of a touch display panel in FIGS. 10A and 10B.

FIGS. 12 and 13 are schematic diagrams of a single-layer electrode structure according to two embodiments.

### DETAILED DESCRIPTION OF THE INVENTION

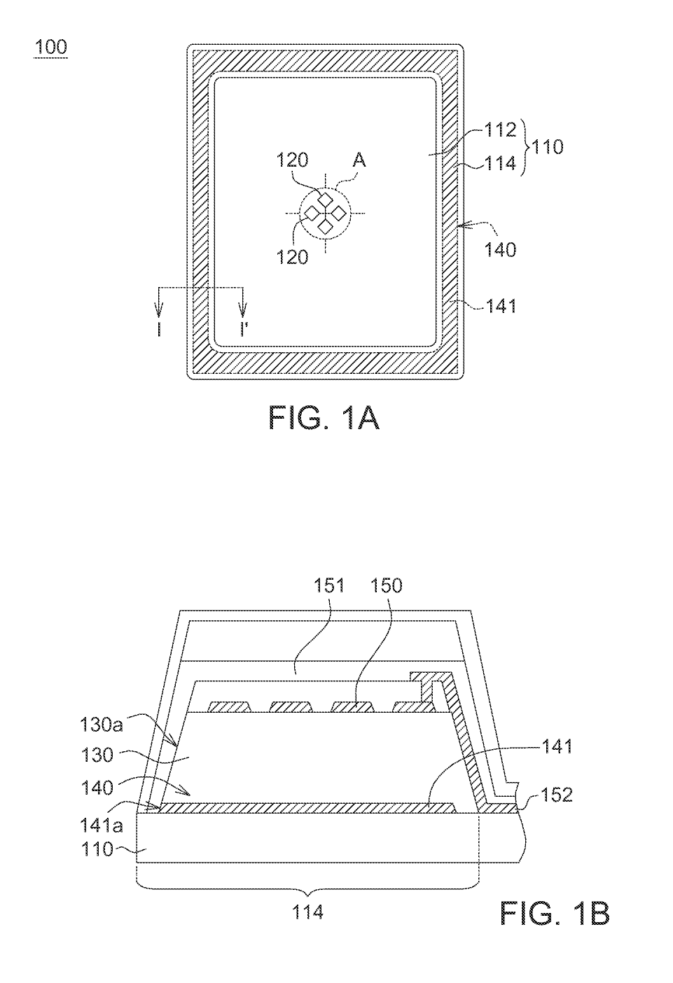

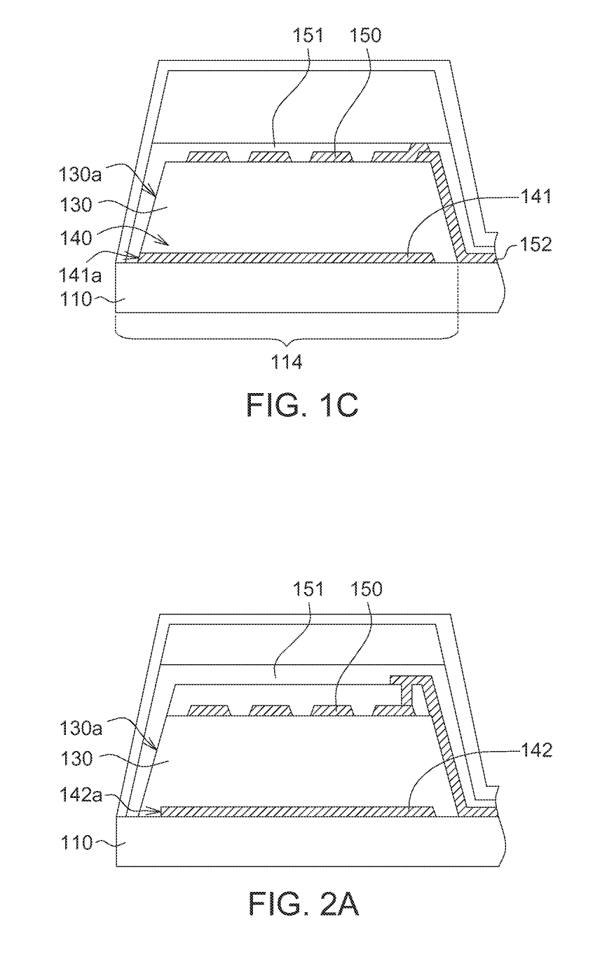

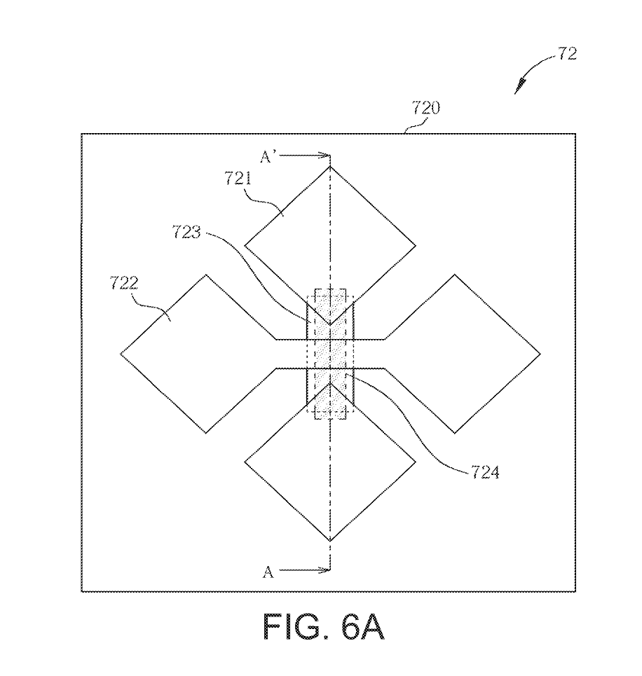

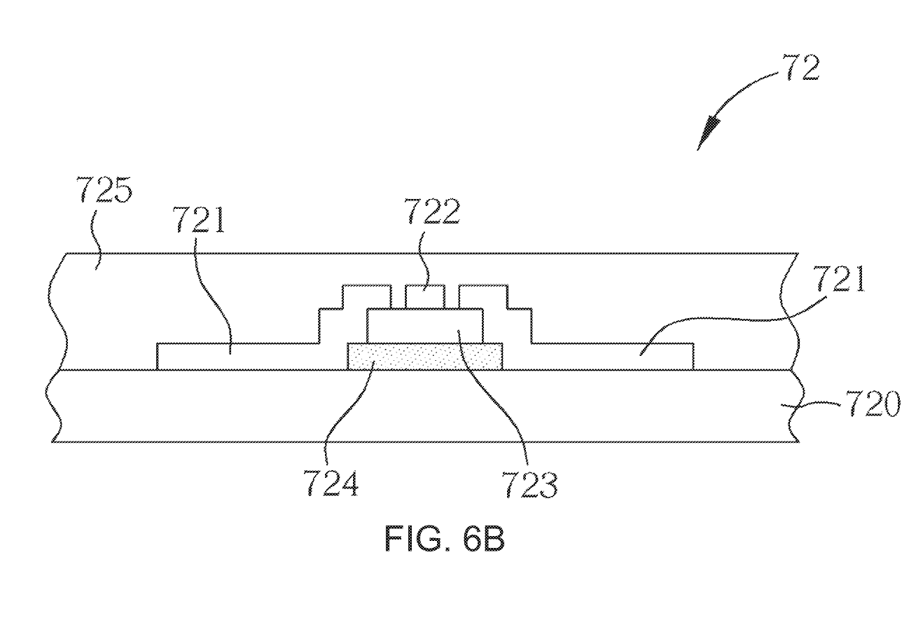

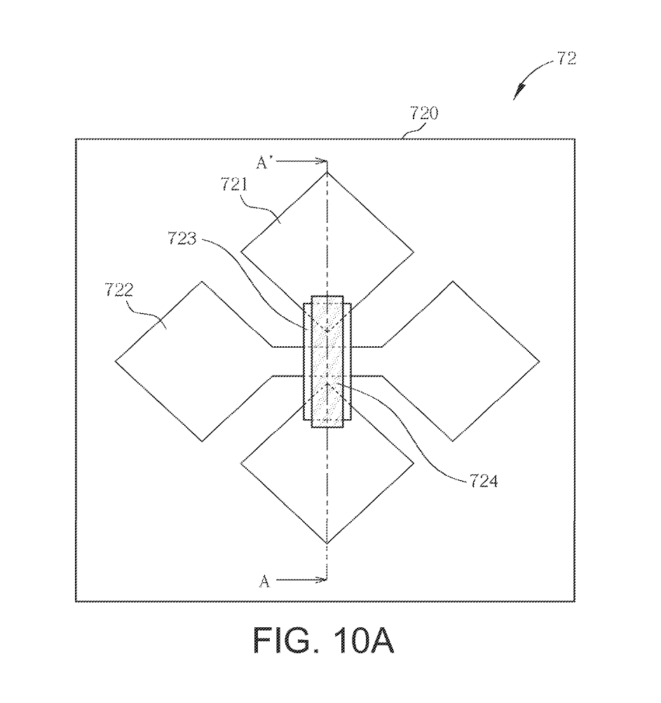

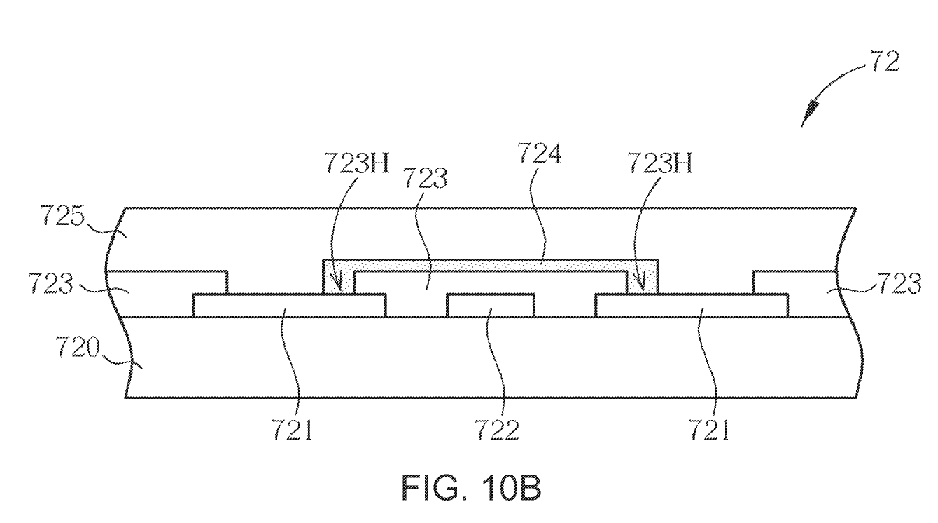

FIG. 1A shows a schematic diagram of a touch panel having an electrostatic protection structure according to an embodiment of the present invention. FIGS. 1B and 1C show sectional views along a section line I-I′ in FIG. 1A according to two embodiments of the present invention. The touch panel 100 includes a transparent substrate 110, multiple sensing electrodes 120, a decoration layer 130 and an electrostatic protection structure 140. The transparent substrate 110 has an active region 112 and a decoration region 114 surrounding the active region 112. The active region 112 corresponds to a display region for displaying an image and a sensing region A for sensing a touch control. The sensing electrodes 120 of the touch sensing element can be formed on the active region 112 for allowing a user to input a touch control. Detailed structures of the touch sensing element shall be described with references FIGS. 6A to 6B, FIGS. 7 to 9, FIGS. 10A to 10B, and FIG. 11 shortly.

Referring to FIGS. 1B and 1C, the decoration layer 130 is disposed on the decoration region 114 to form a non-transparent region around the active region 112. Multiple conductive wires 150 can be disposed on the decoration layer 130. Via the conductive wires 150, the sensing electrodes 120 on the active region 112 of the touch panel 100 may connect to a driver chip (not shown), which may further electrically connect to an external flexible printed circuit board (not shown). A conductive ring 141 is disposed below the decoration layer 130. The conductive ring 141 is disposed in a surrounding arrangement corresponding to the decoration region 114, and is located between the decoration layer 130 and the transparent substrate 110. In this embodiment, the conductive ring 141, serving as the electrostatic protection structure 140, is levelly formed on the inner sides of the transparent substrate 110, and the decoration layer 130 is covered on the conductive ring 141. Thus, the conductive ring 141 does not affect the light transmittance of the active region 112, and the conductive ring 141 completely covers the periphery of the touch panel 100, thereby enhancing the electrostatic protection capabilities of the conductive ring 141. From a perspective of electrostatic discharge, the static electricity accumulated on the transparent substrate 110 chooses a shortest path for discharge. Since a distance between the conductive ring 141 and the transparent substrate 110 is shorter than distances between other metal conductive wires (e.g., the conductive wires 150 on the decoration layer 130 or conductive wires (not shown) located on a cover layer 151) and the transparent substrate 110, the static electricity may be discharged before entering the conductive wires 150, so as to prevent internal devices of the touch panel 100 from being damaged by static electricity.

In this embodiment, the conductive ring 141 may be a transparent conductive ring such as a transparent metal oxide film made of indium tin oxide (ITO), aluminum zinc oxide (AZO), indium zinc oxide (IZO), zinc gallium oxide (GZO), or fluorine tin oxide (FTO). Further, the conductive ring 141 may also be a conductive ring made of metal such as copper, silver, nickel, gold, or any alloy thereof. During a manufacturing process of the touch panel 100, a lower metal oxide layer (e.g., an ITO film) is usually formed on the active region 112 before forming the decoration layer 130. In this embodiment, the conductive ring 141 may be formed at the same time on the decoration region 114 when forming a lower metal oxide layer 152 (referring to FIGS. 1B and 1C), and the decoration layer 130 is then covered on the conductive ring 141. Therefore, no additional manufacturing process and costs are required.

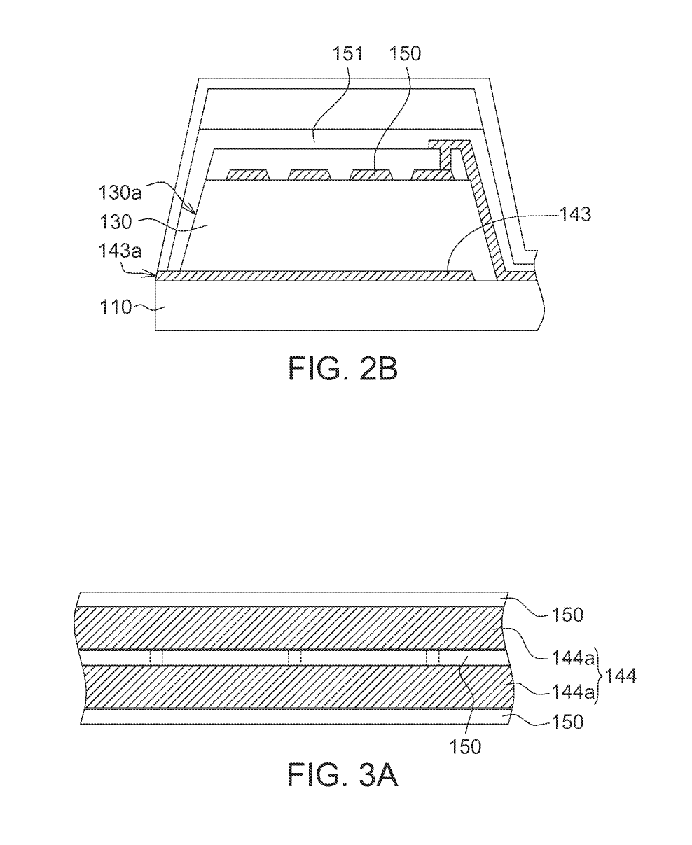

As shown in FIGS. 1B and 1C, the conductive ring 141 and the decoration layer 130 are overlapped, and a sidewall 141a of the conductive ring 141 and a sidewall 130a of the decoration layer 130 are aligned. FIGS. 2A and 2B show a conductive ring according two other embodiments. Referring to FIG. 2A, a main difference from the conductive ring 141 in FIGS. 1B and 1C is that, a sidewall 142a of a conductive ring 142 in FIG. 2A is decreased inwardly by a predetermined size relative to the sidewall 130a of the decoration layer 130, such that the sidewall 142a of the conductive ring 142 is covered within the decoration layer 130. Referring to FIG. 2B, a main difference from the conductive ring in FIGS. 1B and 1C is that, a sidewall 143a of a conductive ring 143 in FIG. 2B is increased outwardly by a predetermined size relative to the sidewall 130a of the decoration layer 130 and extended towards one side of the transparent substrate 110, such that the sidewall 143a of the conductive ring 143 is revealed outside the decoration layer 130.

As shown in FIGS. 1B and 1C, the conductive ring 141 is a complete plane, in a way that the light transmittance of the conductive ring 141 (transparent conductive ring) does not result in visual differences. Further, to prevent the conductive ring 141 from interfering transmitted signals of the conductive wires 150 due to signal coupling, a conductive ring capable of reducing signal coupling may be designed.

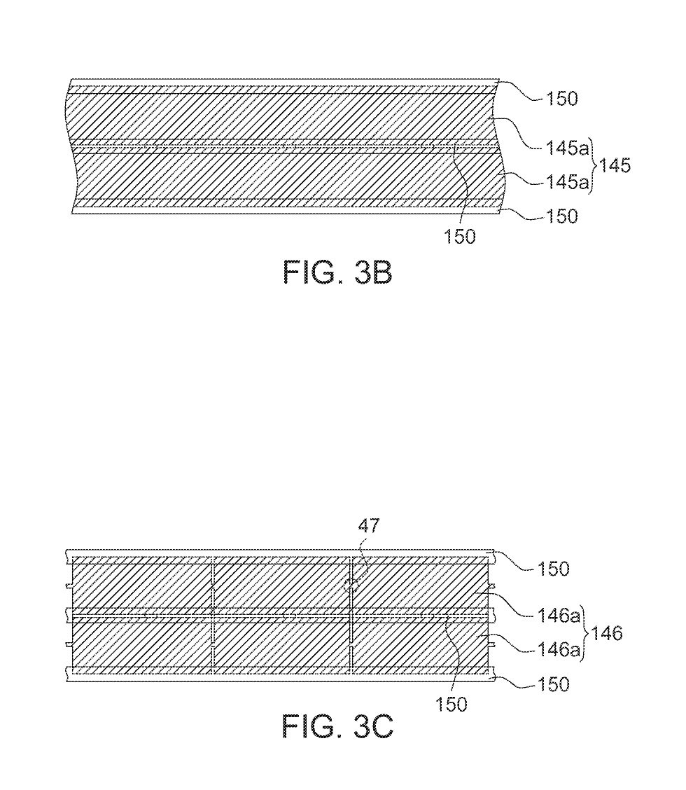

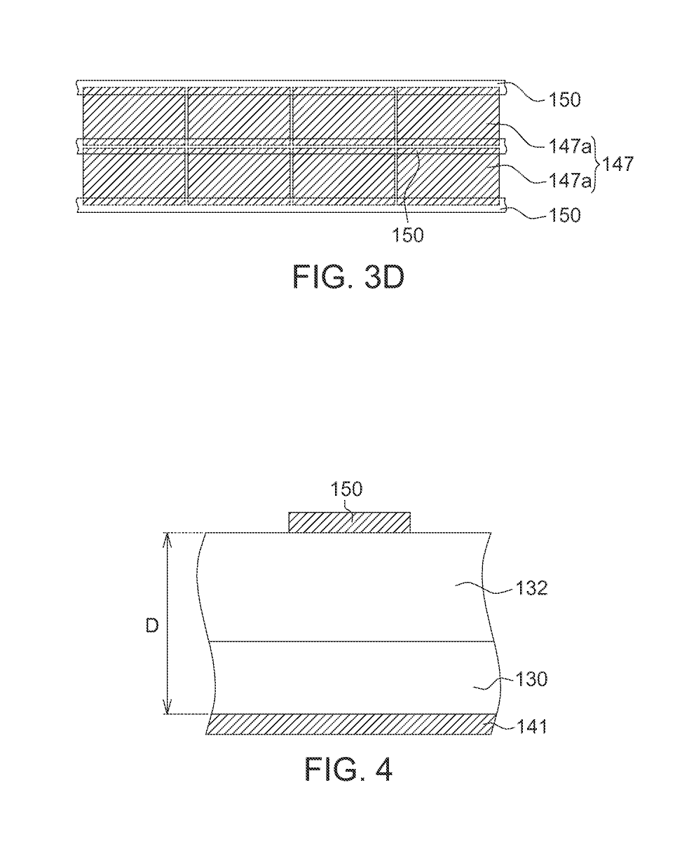

FIGS. 3A to 3C show three schematic diagrams of a conductive ring according to three other embodiments of the present invention. Main differences between the conductive ring in FIGS. 3A to 3B from the conductive ring 141 in FIGS. 1B and 1C are as follows. In FIG. 3A, a conductive ring 144 includes a plurality of columns of strip regions 144a extended in parallel and vertically connected. Each of the conductive wires 150 passes between two adjacent strip regions 144a, and the conductive wires 150 are non-overlapping with the strip regions 144a, so as to reduce an amount of coupling between the conductive wires 150 and the strip regions 144a. In FIG. 3B, a conductive ring 145 includes a plurality of columns of strip regions 145a extended in parallel and vertically connected. Each of the conductive wires 150 passes between two adjacent strip regions 145a, and the conductive wires 150 are partially overlapped with the strip regions 145a to reduce the amount of coupling. However, although signal coupling is generated by the overlapped parts, the light transmittance of the conductive ring 145 remains free from causing visual differences that may be resulted by a large distance as two adjacent strip regions 145a are located close to each other. In FIG. 3C, a conductive ring 146 includes a plurality of columns of block regions 146a that are extended in parallel as well partially and vertically connected. The block regions 146a of the same column are connected via a micro connecting line 147, each of the conductive wires 150 passes between the block regions 146a of two adjacent columns, and the conductive wires 150 are partially overlapped with the block regions 146a, so as to reduce the amount of coupling. For example, the block regions 146a may be formed by regular patterns such as squares, circles or hexagons, or other irregular patterns. Since the patterns of the block regions 146a cover the entire decoration region 114 and are connected into an integral, an all-round electrostatic protection effect is achieved.

FIG. 3D shows a conductive ring according to another embodiment. A conductive ring 147 includes block regions 147a arranged in an array, and the block regions 147a at a reduced size are totally separated one another. Thus, the amount of coupling can be further reduced without generating visual differences. Each of the conductive wires 150 passes between the block regions 147a of two adjacent columns, and the conductive wires 150 are overlapped at one side or two sides of the block regions 147a, or partially overlapped with the block regions 147a. Patterns of the block regions 147a cover the entire decoration region 114 to appear as a surrounding shape, and so an all-round electrostatic protection effect is achieved.

The amount of capacitance coupling between the conductive wires 150 and the conductive ring 141 may be improved by increasing a distance or an appropriate dielectric constant. From the capacitance formula, it is known that capacitance C=dielectric constant*A/d, where A is a coupling area and d is a thickness of a dielectric material. As the dielectric constant gets smaller or when the thickness (d) gets larger, the capacitance (C) becomes smaller. Conversely, as the dielectric constant gets larger or when the thickness (d) gets smaller, the capacitance (C) becomes larger. Thus, by selecting the dielectric material having an appropriate thickness, the distance between the conductive wires 150 and the conductive ring 141 may be increased while the capacitance is further reduced by using a material having a low dielectric constant, so as to lower the amount of coupling.

FIG. 4 depicts a dielectric layer 132 and the decoration layer 130 between the conductive wire 150 and the conductive ring 141. In this embodiment, the dielectric layer 132 may be formed on the decoration layer 130 to increase a distance D between the conductive wire 150 and the conductive ring 141. Meanwhile, the dielectric layer 132 may be a material having a low dielectric constant for further reducing the capacitance. The dielectric layer 132 having an appropriate thickness and an appropriate dielectric constant may be selected according to the values below. For example, before adding the dielectric layer 132, the thickness of the decoration layer 130 is only 1.4 μm, and so the amount of capacitance coupling rises up to 68.3 pf. After adding the dielectric layer 132, the amount of capacitance coupling drops to below 10 pf after increasing the thickness of the dielectric layer 132 to 8 μm. Assuming that a dielectric material having a dielectric constant of 2 is selected, the amount of capacitance coupling is only 7.86 pf.

| Dielectric | Thickness of dielectric layer/Capacitance | | | | |
|---|---|---|---|---|---|
| constant | 1 μm | 2 μm | 4 μm | 8 μm | 16 μm |
| 3 | 36.57 pf | 25.57 pf | 16.74 pf | 10.63 pf | 6.99 pf |
| 2.5 | 33.40 pf | 22.94 pf | 14.73 pf | 9.28 pf | 6.09 pf |
| 2 | 29.65 pf | 19.85 pf | 12.58 pf | 7.86 pf | 5.17 pf |

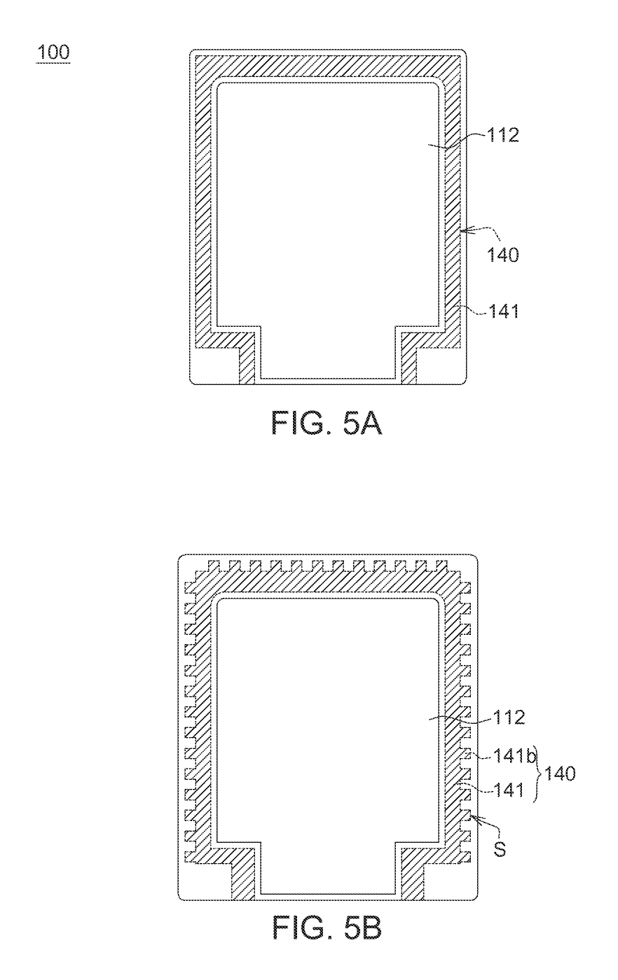

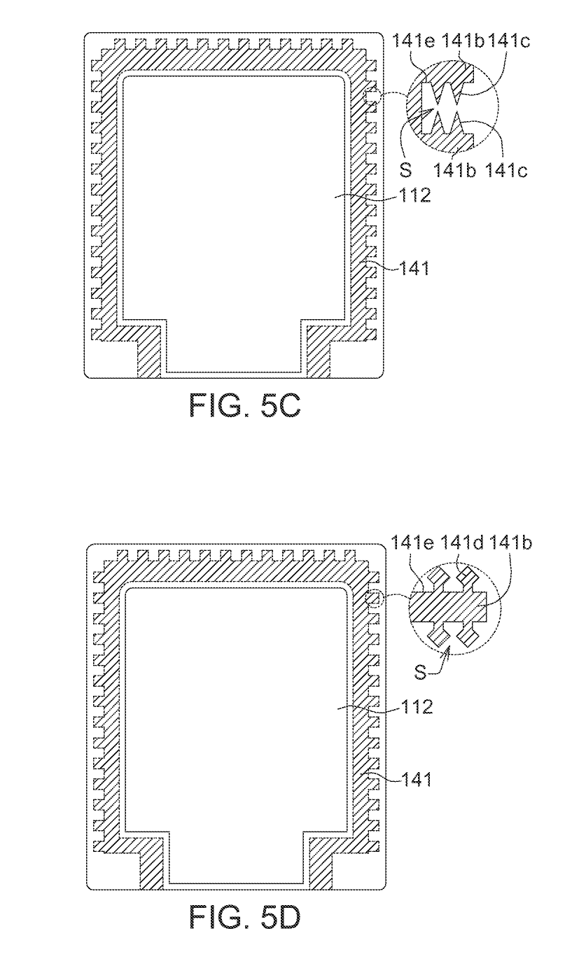

FIGS. 5A to 5D show an electrostatic protection structure according to various embodiments. In FIG. 5A, the electrostatic protection structure 140 may be a conductive ring 141 surrounding the active region 112 of the touch panel 100. In FIG. 5B, the electrostatic protection structure 140 further includes a plurality of protruding portions 141b extending outwardly from the periphery of the conductive ring 141. Thus, electrostatic energy is more easily attracted to prevent the electrostatic energy from jumping towards the active region 112. In FIG. 5C, each of the protruding portions 141b further includes a plurality of tapered portions 141c extending outwardly from sidewalls 141e of the protruding portion 141b. Further, pointed ends S of the tapered portions 141c are located facing to one another to reduce spacing. In FIG. 5D, the each of the protruding portions 141b further includes a plurality of rhombus portions 141d extending outwardly from the sidewalls 141e of the protruding portion 141b, and pointed ends S of the rhombus portions 141d are located facing one another to reduce spacing. Hence, in this embodiment, the electrostatic protection structure 140 may release electrostatic energy near the pointed ends S of the above-mentioned protruding portions 141b, the tapered portions 141c and/or the rhombus portions 141d to further enhance electrostatic protection capabilities.

FIG. 6A shows a top view of a touch sensing element disposed in a sensing region in FIG. 1A. FIG. 6B shows a sectional view of the touch sensing element in FIG. 6A along a section line A-A′. Referring to FIGS. 6A and 6B, in this embodiment, for example, the touch sensing element is a capacitive touch sensing element 72 including a substrate 720, a bridge connection wire 724, an insulation layer 723, a plurality of first electrodes 721, and a plurality of second electrodes 722. The bridge connection wire 724 is disposed on the substrate 720. The insulation layer 723 covers on the bridge connection wire 724, and reveals two ends of the bridge connection wire 724 and a part of the substrate 720. The first electrodes 721 are located on the substrate 720, and are electrically connected to the two revealed ends of the bridge connection wire 724. The second electrodes 722 are located on the insulation layer 723, and two adjacent second electrodes 722 may be for example, directly connected. Further, a protection layer 725 may be additionally provided on the first electrodes 721, the second electrodes 722, the insulation layer 723 and the bridge connection wire 724. In this embodiment, the bridge connection wire 724 may be a single-layer bridge connection wire such as a metal bridge connection wire or a transparent conductive bridge connection wire (e.g., ITO), or a composite-layer bridge connection wire such as a stacked structure formed by a metal material and a transparent conductive material. The first electrodes 721 and the second electrodes 722 may be formed from a same transparent material and patterned using a same manufacturing process.

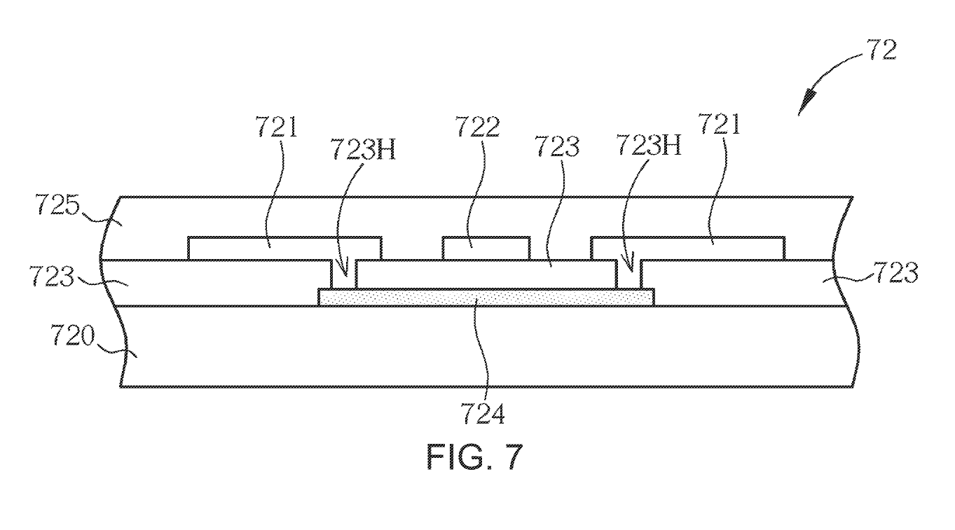

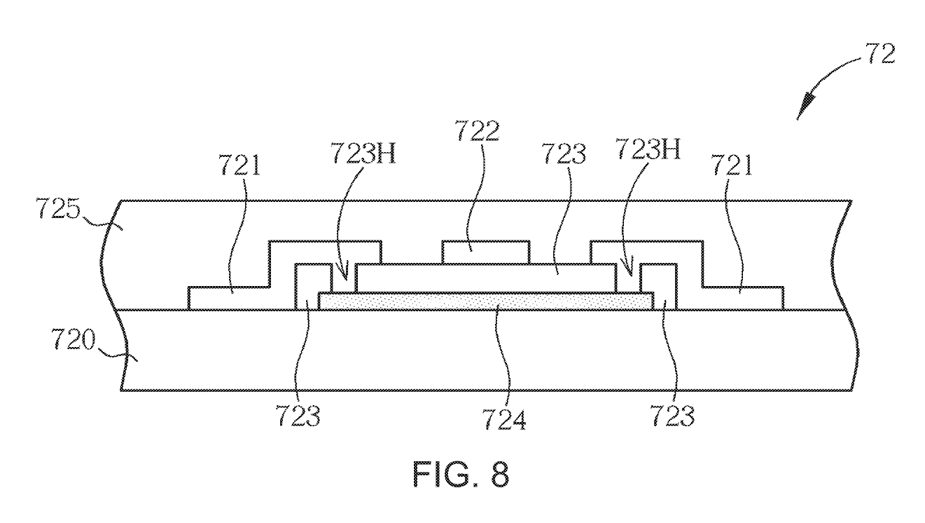

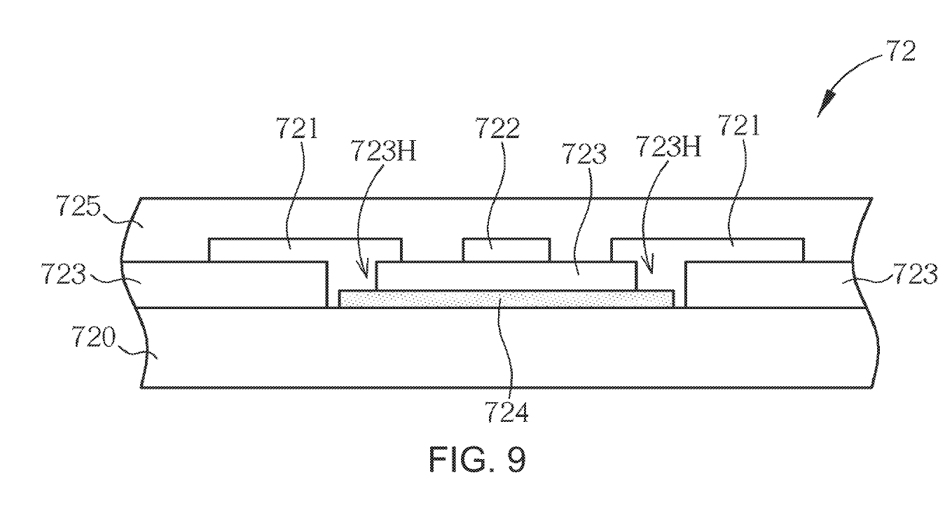

FIGS. 7 to 9 show schematic diagrams of three variations of the touch sensing element in FIGS. 6A and 6B, respectively. Referring to FIGS. 7 to 9, the variations according to the three embodiments in FIGS. 7 to 9 are similar to that in FIGS. 6A and 6B, with a main difference being that, in the three embodiments, the first electrodes 721 is electrically connected to the bridge connection wire 724 via a contact hole 723H of the insulation layer 723, and the contact hole 723H reveals only the bridge connection wire 724 (as shown in FIGS. 7 and 8), or reveals the bridge connection wire 724 and a part of the substrate 720 (as shown in FIG. 9). Further, the insulation layer 723 may also completely cover the substrate 720 (as shown in FIG. 7) or cover only a part of the substrate 720 (as shown in FIG. 8).

FIG. 8A shows a top view of a top view of a touch sensing element disposed in a sensing region in FIG. 1A. FIG. 8B shows a sectional view of the touch sensing element in FIG. 8A along a section line A-A′. Again referring to FIGS. 8A and 8B, in this embodiment, for example, the touch sensing element is a capacitive touch sensing element 72 including a substrate 720, a plurality of first electrodes 721, a plurality of second electrodes 722, an insulation layer 723 and a bridge connection wire 724. In this embodiment, the first electrodes 721 and the second electrodes 722 may be formed from a same transparent conductive material and are disposed on the substrate 720. The insulation layer 723 covers on the substrate 720, the first electrodes 721 and the second electrodes 722, and reveals a part of the first electrodes 721. The bridge connection wire 724 is disposed on the insulation layer 723, and is electrically connected to an adjacent first electrode 721 revealed at a contact hole 723H. For example, adjacent second electrodes 722 are directly connected. Further, a protection layer 725 may be disposed on the insulation layer 723 and the bridge connection wire 724.

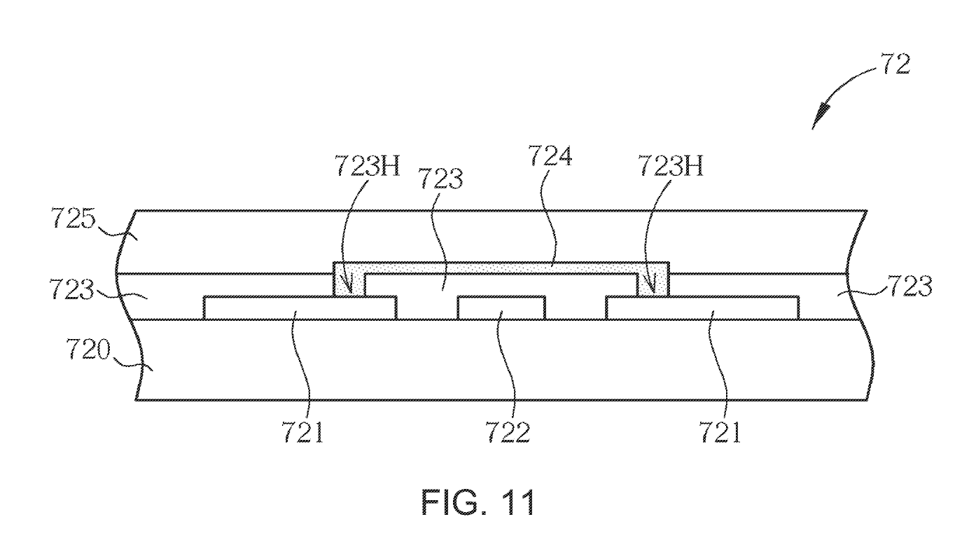

FIG. 11 shows a schematic diagram of a variation of a touch sensing element of the touch display panel in FIGS. 8A and 8B. The variation according to the embodiment in FIG. 11 is similar to the embodiment in FIGS. 8A and 8B, with a main difference being that, in this embodiment, the bridge connection wire 724 completely fills the contact hole 723H of the insulation layer 723 to be electrically connected with the first electrodes 721.

The structure of the touch sensing element of the present invention is not limited to those described in the embodiments. For example, the first electrodes 721 and the second electrodes 722 may be manufactured from different materials, and the first electrodes 721 may be directly connected rather than being electrically connected via the bridge connection wire 724 under such situations.

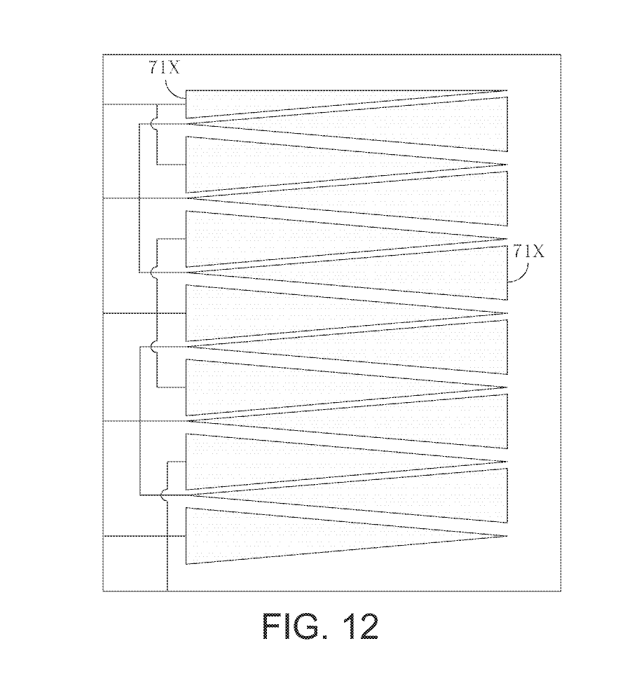

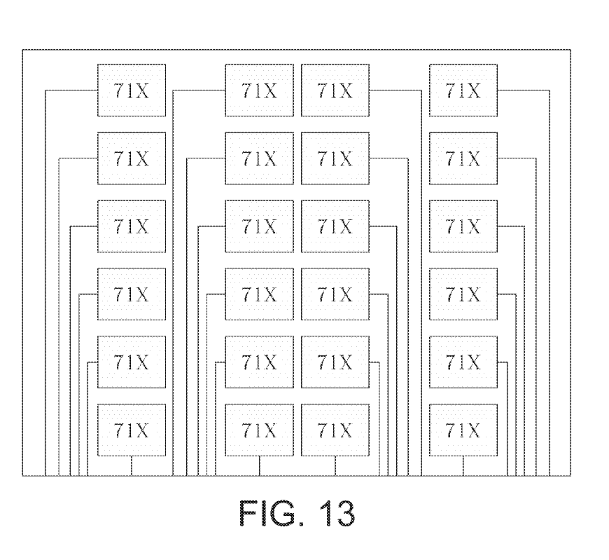

It should be again noted that, the foregoing electrodes and variations thereof are not limited to the first electrodes and the second electrodes described in the above embodiments. The electrodes of the present invention may be single-layer electrodes in any form, e.g., a single-layer electrode structure formed by a plurality of triangular electrodes 71X (as shown in FIG. 12) or a plurality of rectangular electrodes 71X (as shown in FIG. 13). Further, the electrodes 71X may be a same conductive pattern or different conductive patterns.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch panel having an electrostatic protection structure, comprising:
a transparent substrate, having an active region and a decoration region surrounding the active region;
a plurality of sensing electrodes, formed on the active region;
a decoration layer, disposed on the decoration region; and
an electrostatic protection structure, comprising a conductive ring, disposed in a surrounding arrangement corresponding to the decoration region, and located between the decoration layer and the transparent substrate.

2. The touch panel according to claim 1, wherein the conductive ring is a transparent conductive ring or a metal conductive ring.

3. The touch panel according to claim 1, further comprising a plurality of conductive wires disposed on the decoration layer, and positions of the conductive wires are opposite to a position of the conductive ring.

4. The touch panel according to claim 3, wherein the conductive ring comprises a plurality of columns of strip regions extended in parallel and vertically connected, each of the conductive wires passes between two adjacent strip regions, and the conductive wires and the strip regions are non-overlapped.

5. The touch panel according to claim 3, wherein the conductive ring comprises a plurality of columns of strip regions extended in parallel and vertically connected, each of the conductive wires passes between two adjacent strip regions, and the conductive wires and the strip regions are partially overlapped.

6. The touch panel according to claim 3, wherein the conductive ring comprises a plurality of columns of block regions extended in parallel and vertically connected, the block regions of the same column are connected to one another via a micro connecting line, each of the conductive wires passes between the block regions of two adjacent columns, and the conductive wires and the block regions are partially overlapped.

7. The touch panel according to claim 3, wherein the conductive ring comprises a plurality of columns of parallel and unconnected block regions, each of the conductive wires passes between the block regions of two adjacent columns, and the conductive wires and the block regions are partially overlapped.

8. The touch panel according to claim 3, further comprising a dielectric layer, and the dielectric layer is formed on the decoration layer and is located between the conductive wires and the conductive ring.

9. The touch panel according to claim 1, wherein the conductive ring overlaps with the decoration layer, and a sidewall of the conductive ring and a sidewall of the decoration layer are aligned.

10. The touch panel according to claim 1, wherein a sidewall of the conductive ring is reduced inwardly by a predetermined size relative to a sidewall of the decoration layer, or is increased outwardly by a predetermined size relative to the sidewall of the decoration layer.

11. The touch panel according to claim 1, wherein the electrostatic protection structure further comprises a plurality of protruding portions extending outwardly from a periphery of the conductive ring.

12. The touch panel according to claim 11, wherein each of the protruding portions further comprises at least one tapered portion extending outwardly from a sidewall of the protruding portion, and pointed ends of the tapered portions are located facing one another.

13. The touch panel according to claim 11, wherein each of the protruding portions further comprises at least one rhombus portion extending outwardly from a sidewall of the protruding portion, and pointed ends of the rhombus portions are located facing one another.
